(19) United States
(12) Patent Application Publication
(10) Pub. No.: US 2008/0046270 A1
(43) Pub. Date: Feb. 21, 2008

(54) System and Method for AV Rentals and Sales Including Specific Assessment Tools

(76) Inventor: Steve Scott, San Antonio, TX (US)

Correspondence Address: WHITE-WELKER & WELKER, LLC, P.O. BOX 199, CLEAR SPRING, MD, 21722-0199, US

(21) Appl. No.: 11/838,819

(22) Filed: Aug. 14, 2007

Related U.S. Application Data
(60) Provisional application No. 60/822,388, filed on Aug. 15, 2006.

(51) Int. Cl. G06Q 90/00

(52) U.S. Cl. 705/1

(57) ABSTRACT

The present invention is an online software process that organizes and manages audio visual product and service with information for estimating, comparative analysis, selection and rental or purchase further including specific assessment tools. Disclosed is a system that provides pricing transparency and removes the mystery related to pricing structures and further provides a tool for accountability related to variables in pricing. The system additionally eliminates redundancy, providing multiple output options from one database and further providing enterprise wide storage and tracking of historical data for easy future reference and analysis. Finally, the system allows for accurate product-to-product and service-to-service comparative analysis thereby reducing time required in a Request for Proposal or Budget Estimate process.

### CROSS REFERENCE TO RELATED APPLICATIONS

This application claims priority from U.S. Provisional Patent Application Ser. No. 60/822,388, entitled “System and Method for AV Rentals and Sales Including Specific Assessment Tools”, filed on 15 Aug. 2006.

### FEDERALLY SPONSORED RESEARCH

Not Applicable

### SEQUENCE LISTING OR PROGRAM

Not Applicable

### TECHNICAL FIELD OF THE INVENTION

The present invention relates generally to solutions that organize and manage audio visual product and service information. More specifically, the present invention relates to solutions that organize and manage audio visual product and service information for web-based estimating, comparative analysis, selection and rental or purchase.

### BACKGROUND OF THE INVENTION

Those with practical hands-on experience working with and for AV (audio visual) companies as well as hundreds of informal face-to-face interviews have lead to a better understanding of the challenges customers and AV companies both face in the estimating, rental, purchase, and tracking audio visual products and service information.

Customers of AV rental companies and those working for small, medium, and large AV companies are often faced with the responsibility to provide business analysis of information flow through sales, operations, and production departments. It is now known to both workers and customers that there is a fundamental technology gap within virtually every audio visual rental company that must be addressed to provide.

Similar systems dealing with transactions are known in the prior art for the tracking and recording for information such as U.S. Pat. No. 7,020,635 issued to Hamilton, et al. on Mar. 28, 2006 for a system and method that tracks the usage of rented digital assets. A server includes an asset database that stores a digital asset, the title of the digital asset, and a server usage count for the digital asset. The computing device stores a rented digital asset and further stores an asset usage count list that includes the title of the rented digital asset and a usage count that indicates the amount of usage of the rented digital asset by the computing device. The server uploads the asset usage count list from the computing device and matches the title of the rented digital asset from the asset usage count list with the title of the same digital asset stored in the asset database. Further, the server adds the usage count of the rented digital asset to the server usage count for the digital asset in the asset database.

U.S. Pat. No. 6,885,998 issued to Arduino on Apr. 26, 2005 teaches an Internet-based sports equipment rental system and method that enables individuals to rent sports equipment and other items, such as golf clubs, from a renting company's Web site. The system and method includes automated rental processing and tracking software that runs on the renting company's Web site to allow individuals to rent sports equipment conveniently over the Internet for use at predetermined locations at predetermined future times.

U.S. Patent Publication Number 20030120509 of Bruch, et al. published on Jun. 26, 2003 teaches a method and system for processing rental transactions in an equipment rental business. Status information associated with the one or more pieces of equipment is automatically received. Based on this status information, a work function is planned for each piece of equipment, including one or more action items. A comparison is automatically made of the status information with a contract associated with the one or more pieces of equipment. Digital imaging and analysis may be used during this process to assess physical damage to the equipment. The method may be performed on-site at the rental business location or at a remote location.

U.S. Patent Publication Number 20020184122 of Yamaguchi, et al. published on Dec. 5, 2002 teaches a system that allows a required number of pieces of equipment to be efficiently rented out in a desired plan and that enables a charge to be calculated based on the actual usage of the equipment. A set including a plurality of rental equipment of different rental plan is connected to a communication network via public lines or receivers. At least usage information is sent to a rental company, which is connected to the network, and the host computer of the rental company calculates the charge for the equipment based on this usage information.

Therefore, it is an objective of the present invention to teach a system that overcomes the deficiencies known in other similar prior art systems and addresses the challenges customers and AV companies both face in the estimating, rental, purchase, and tracking audio visual products and service information.

A shortcoming of the prior art is that is fails to provide pricing transparency and remove the mystery related to pricing structures and further provides a tool for accountability related to variables in pricing.

Another shortcoming of the prior art is that is fails to teach a system that eliminates redundancy, providing multiple output options from one database and further providing enterprise wide storage and tracking of historical data for easy future reference and analysis.

It is yet another shortcoming of the prior art that it fails to teach a system that allows for accurate product-to-product and service-to-service comparative analysis thereby reducing time required (hours, days or weeks) in a Request for Proposal or Budget Estimate process.

### SUMMARY OF THE INVENTION

The present invention is a system and method for AV rentals and sales including specific assessment tools.

The primary advantage of the present invention is that it teaches a system that provides pricing transparency and removes the mystery related to pricing structures and further provides a tool for accountability related to variables in pricing.

Another advantage of the present invention is that it teaches a system that eliminates redundancy, providing multiple output options from one database and further providing enterprise wide storage and tracking of historical data for easy future reference and analysis.

Still another advantageous aspect of the present invention is that it teaches a system that allows for accurate product-to-product and service-to-service comparative analysis thereby reducing time required (hours, days or weeks) in a Request for Proposal or Budget Estimate process.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a screenshot of the Internet Website Browser Embodiment of the present invention illustrating the Welcome Screen;

FIG. 2 is a screenshot of the Internet Website Browser Embodiment of the present invention illustrating the first step in the process;

FIG. 3 is a screenshot of the Internet Website Browser Embodiment of the present invention illustrating the second step in the process;

FIG. 4 is a screenshot of the Internet Website Browser Embodiment of the present invention illustrating the third step in the process;

FIG. 5 is a screenshot of the Internet Website Browser Embodiment of the present invention illustrating the fourth step in the process;

FIG. 6 is a screenshot of the Internet Website Browser Embodiment of the present invention illustrating the fifth step in the process;

FIG. 7 is a screenshot of the Internet Website Browser Embodiment of the present invention illustrating the sixth step in the process;

FIG. 8 is a screenshot of the Internet Website Browser Embodiment of the present invention illustrating the Budget Estimate with Pricing report;

FIG. 9 is a screenshot of the Internet Website Browser Embodiment of the present invention illustrating the Budget Estimate without Pricing report;

FIG. 10 is a screenshot of the Internet Website Browser Embodiment of the present invention illustrating the Detailed Budget Estimate;

FIG. 11 is a screenshot of the Internet Website Browser Embodiment of the present invention illustrating the Production Copy/Flow Sheets; and

FIG. 12 is a flow cart illustrating several of the outputs that may be generated by a preferred embodiment of the system of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the present invention. The present invention is a system and method for AV rentals and sales including specific assessment tools.

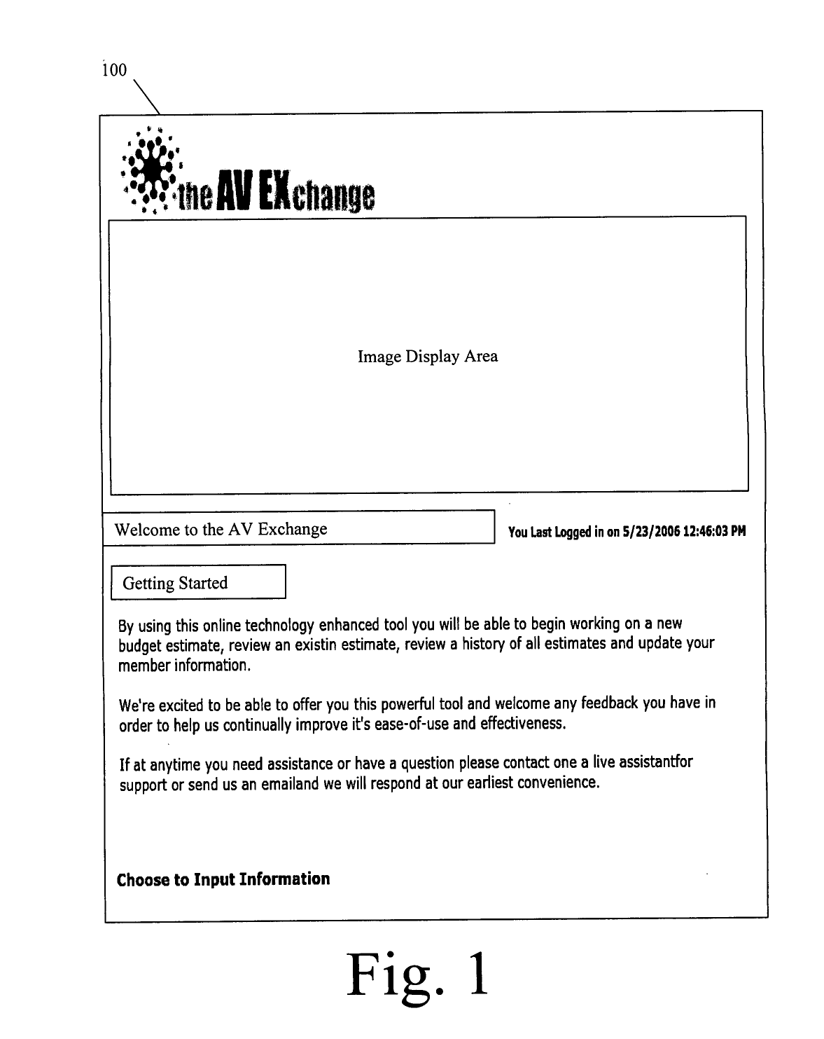

Before a user can engage the system of the present invention, registration must occur where information such as first name, last name, email address, login identification and password are entered. A Welcome Screen 100 is shown in FIG. 1, which provides a user with the information necessary to learn about the features of the system and get started. Once registration has been successfully established, a user can login using their login identification and password to access the system.

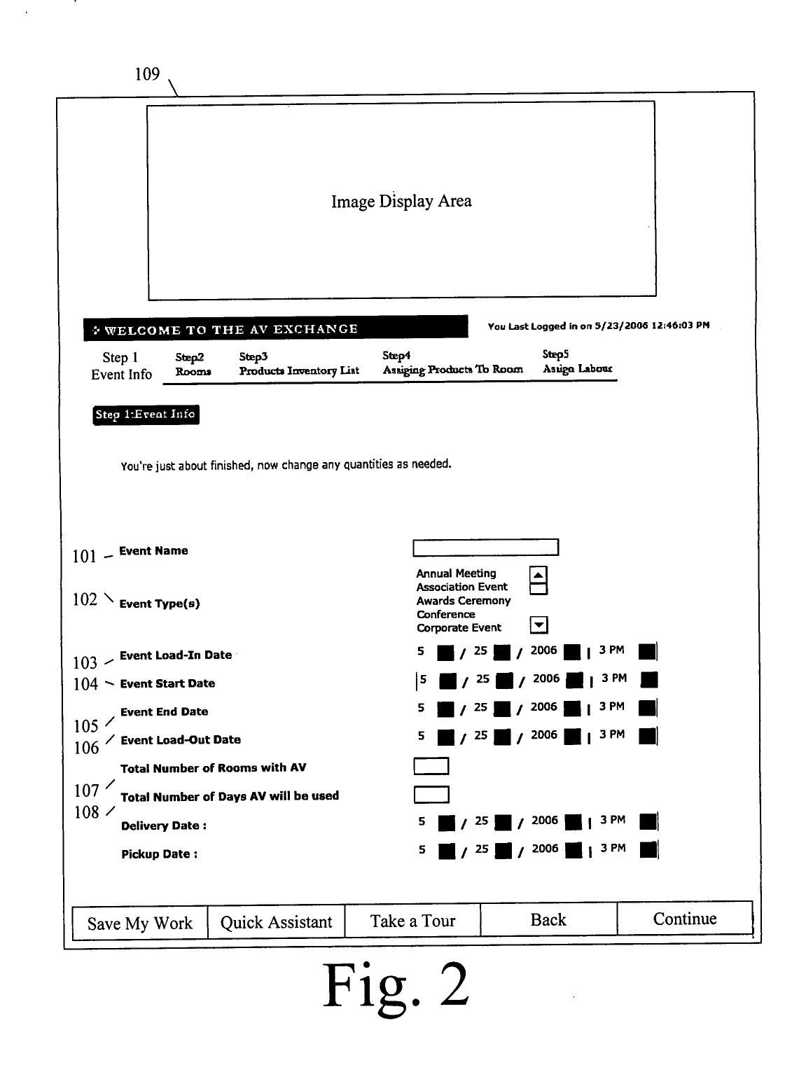

Once a user has logged in, they can select a “new budget estimate” to get started. The user will receive a tracking number and choose to input information themselves, choose to submit information to the system's staff, take a tour of the system's features, or utilize a quick assistant 109 as illustrated in FIG. 2.

Referring again to FIG. 2, Event Information including, but not limited to: Event Name 101, Event Type(s) 102, Event Load-In Date/Time 103, Event Start Date/Time 104, Event End Date/Time 105, Event Load-Out Date/Time 106, Number of Total Rooms with AV 107, and Number of Total Days AV will be used 108 is entered into the system in a first step.

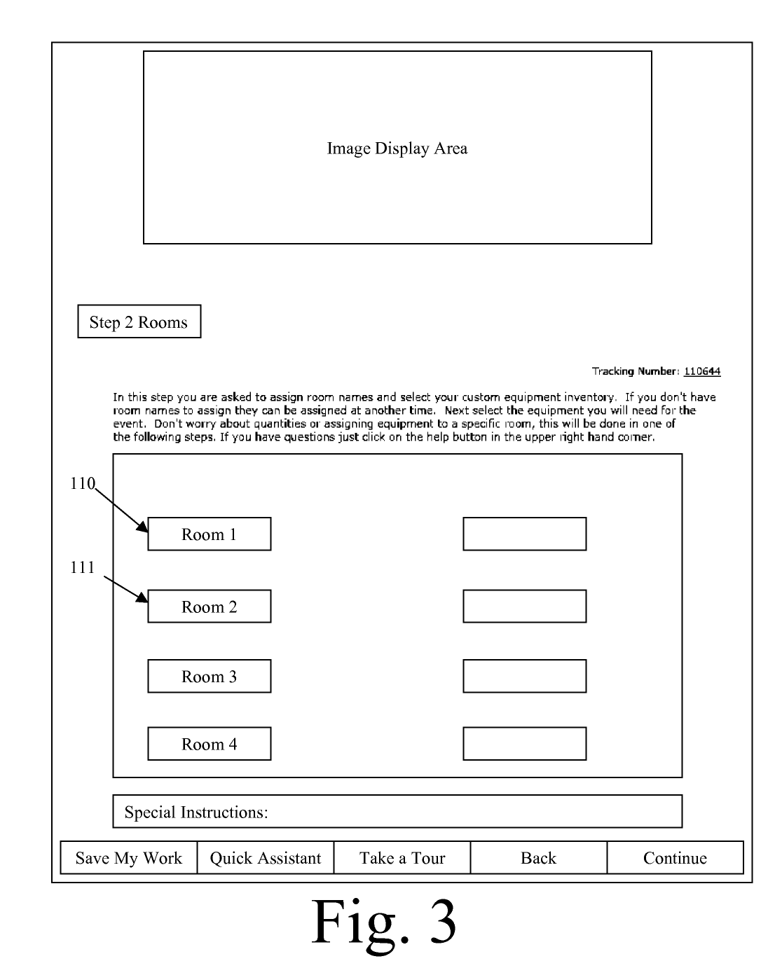

Now referring to FIG. 3, in a second step, Room Name Assignments are entered into the system. For example, Room 1 can be denoted as property or conference room number 110 at the event location, Room 2 can be denoted as a second property or conference room number 111 at the event location, etc. as required.

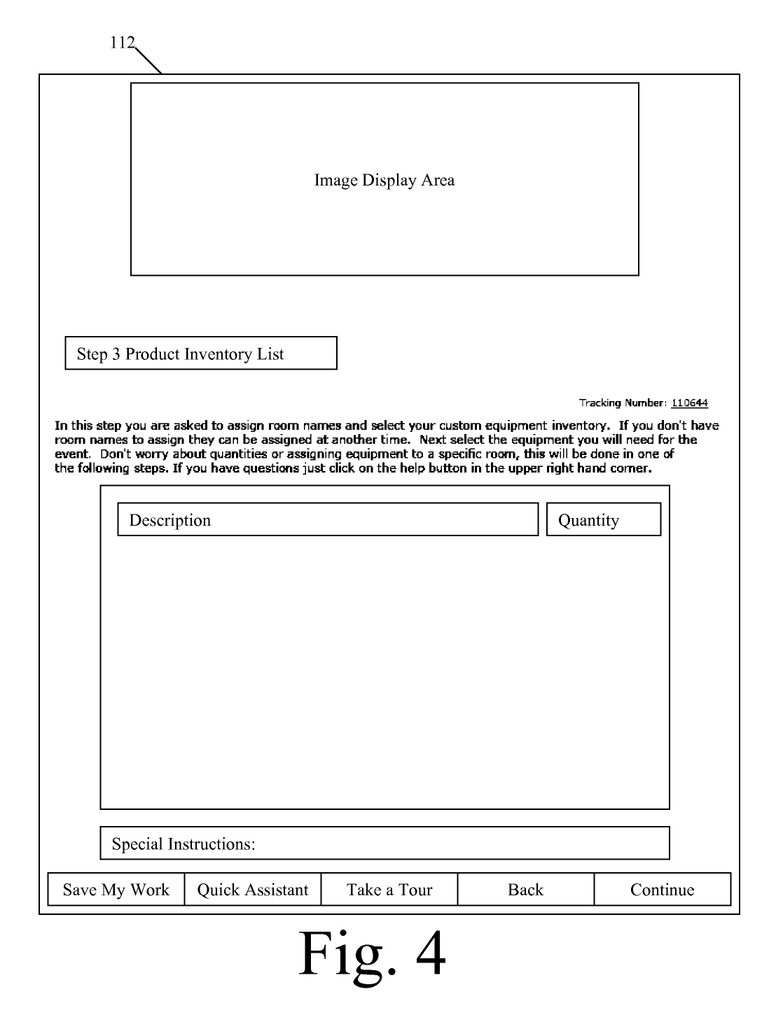

The third step in the process is to create a Product Inventory List 112 as illustrated in FIG. 4. The Products Inventory listed 112 is generated from information provided by or access from multiple AV companies and other AV product suppliers. This will be another unique feature of our system, unlike any that currently exists. A user must indicate the total quantity of products needed for the rooms previously listed and add products not on the list to receive a price quote.

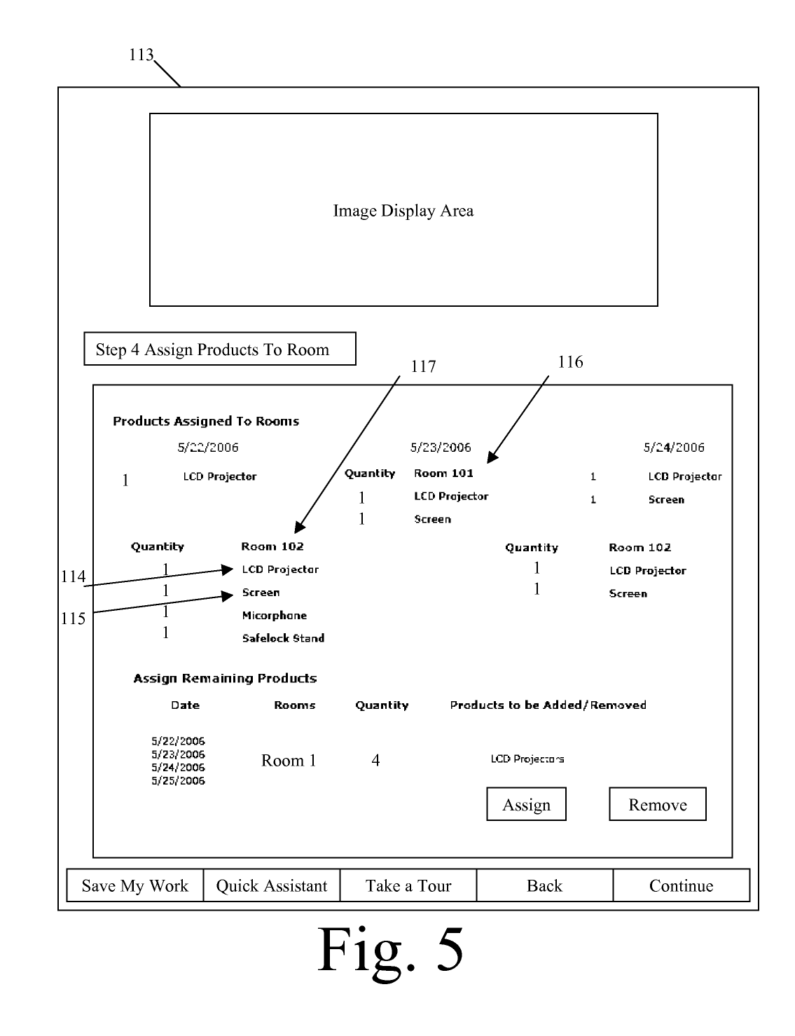

Now referring to FIG. 5, the fourth step in the process, Assigning Products to Rooms 113, is illustrated. In the example there are 3 rooms. The user has selected a plurality of products 114 and 115 (such as LCD Projectors, screens, microphones, etc.) that will be added to their Custom Product Group-Summary Master List (CPG-MSL). Next the products will automatically be assigned per room 116 and 117. This process will repeat itself automatically with each of the products that have equal to or greater quantity values than the number of rooms each being assigned to a room. For products with less than equal to the number of rooms the products would remain in a “To be Assigned” status.

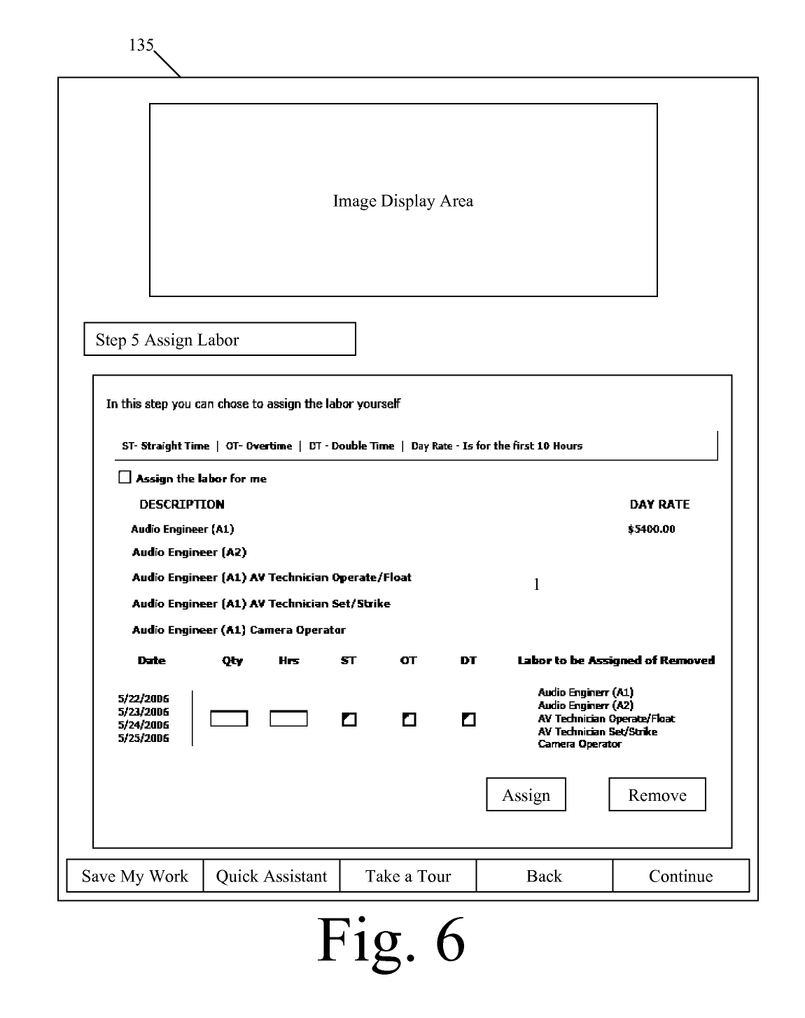

FIG. 6 illustrates the fifth step, assignation of labor 135. In this step a user can choose to assign the labor them self. Straight Time is Monday thru Friday up to 10 hours, Overtime after 10 hours; Overtime is Saturday thru Sunday, Time and a half up to 10 hours, Double-Time after 10 hours Time-and-a-half is applied after 10 hours on weekdays and for the first 10 hours on weekends. Time-and-a-half is applied between 12 am and 6:00 am on weekdays. Time-and-a-half is applied on some Holidays, please check with us if your event occurs over a holiday. Double-Time is applied after 10 hours on weekends and holidays and between 12 am and 6:00 am on weekends.

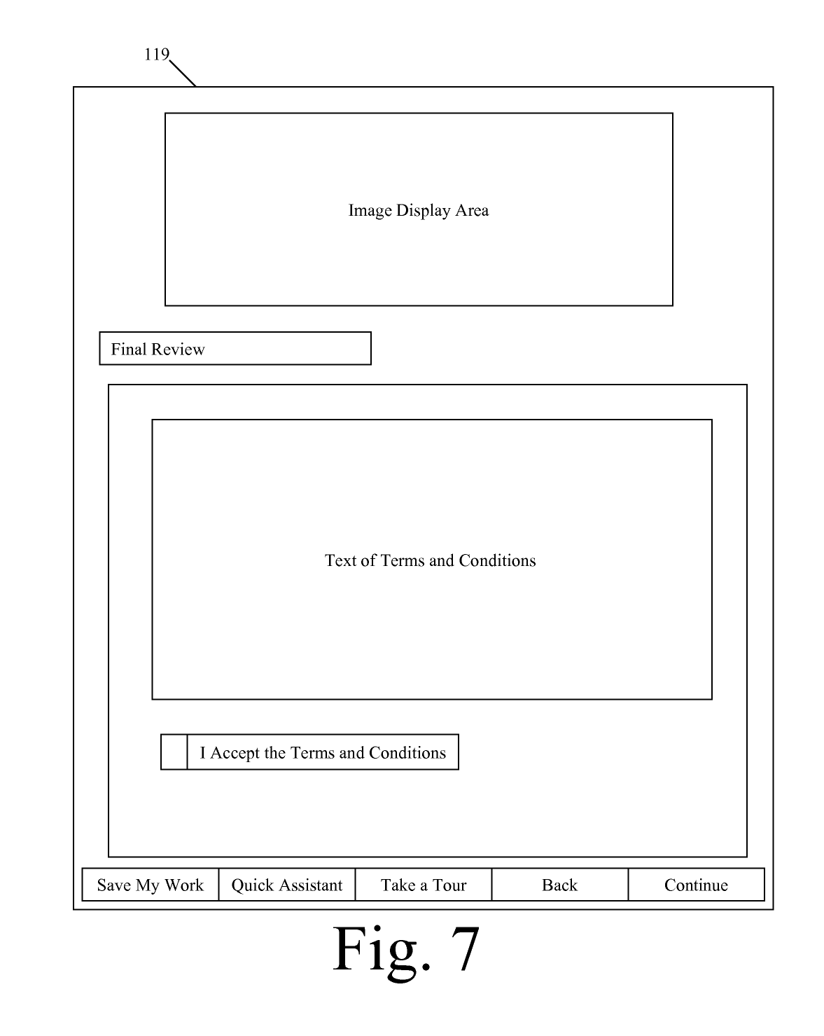

Referring to FIG. 7, the sixth and final step of review 119 is illustrated. Once a user has reviewed the Terms and Conditions 120 they receive a tracking number and may preview and print any of the available forms. Someone from the system's staff will review the order for accuracy and send an email to the user with a copy of the Budget, Estimate Summary with any adjustments or changes that may have been made, along with an Approval Form should the user want to confirm the order.

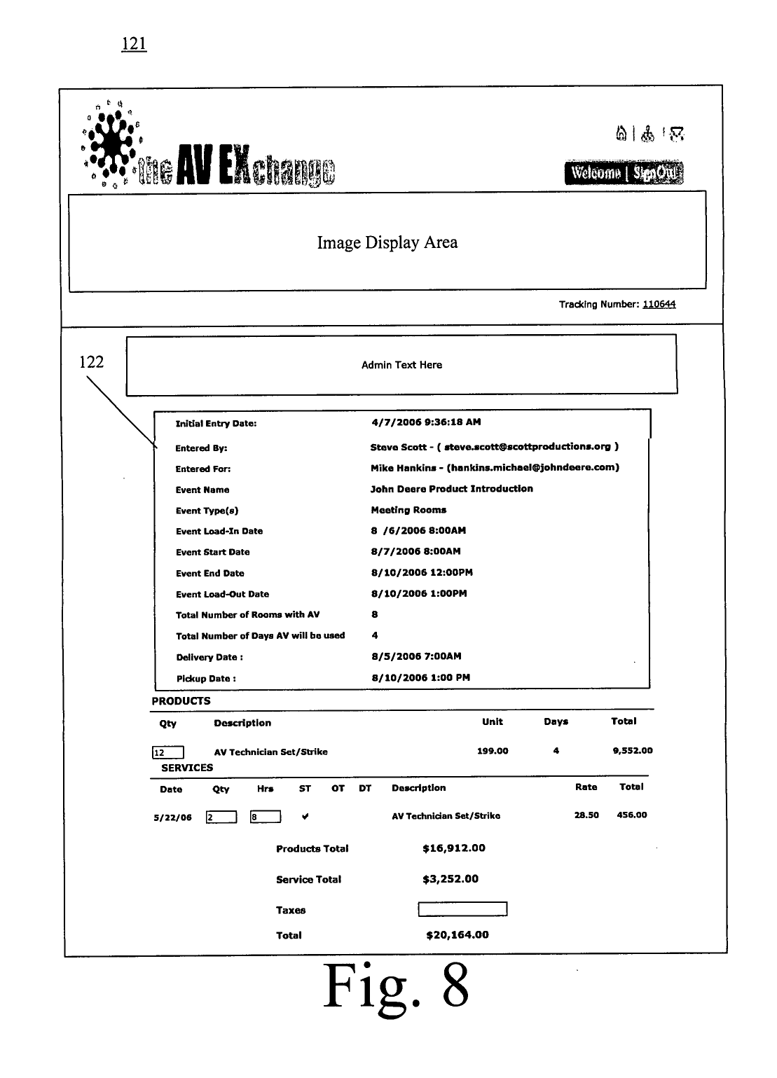

Referring to FIG. 8 a screenshot of the Internet Website Browser Embodiment 121 of the present invention illustrating the Budget Estimate with Pricing report 122 is shown. This report 122 includes a breakdown of event information, products, services, and price total information. The event information includes the dates, name, contact person, system contact, rooms, and time frame. With respect to the products and services an itemized list showing the quantity, unit price, days, and total extended price is shown. The total section a product total, service total, taxes, and total amount due.

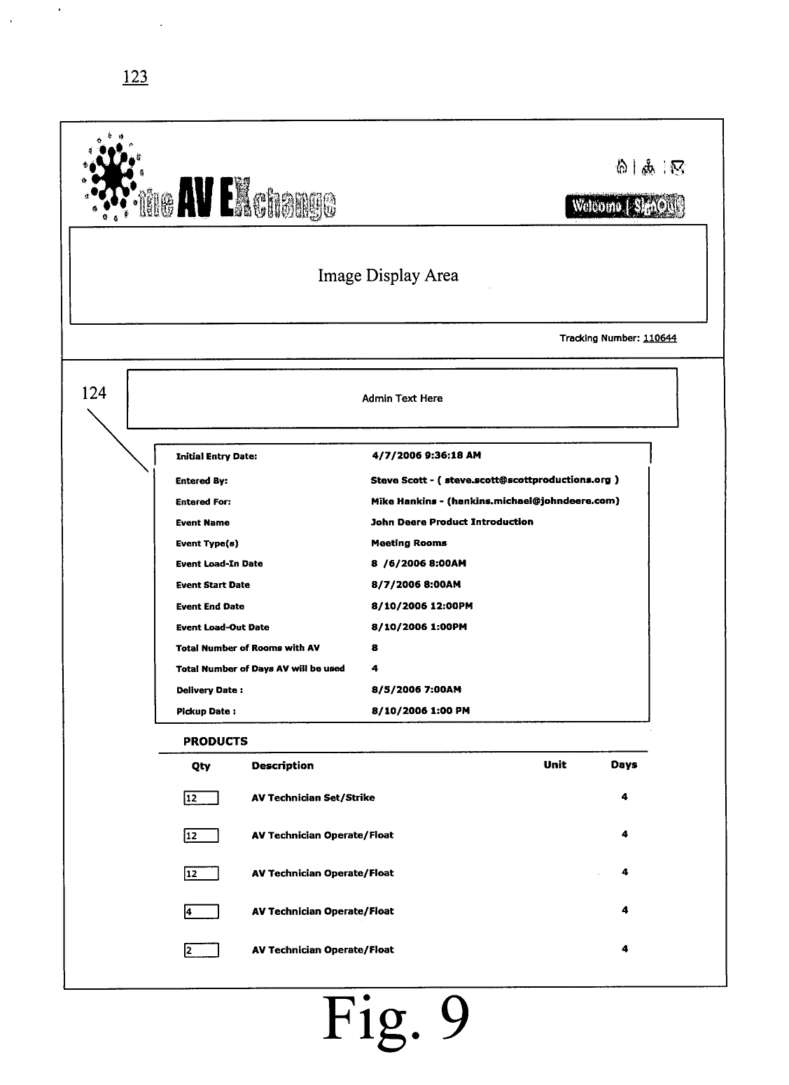

FIG. 9 is a screenshot of the Internet Website Browser Embodiment 123 of the present invention illustrating the Budget Estimate without Pricing report 124. This report includes the same even information as the Budget Estimate with Pricing report but while including the quantity or products and services does not include any unit or extended pricing information or total section values.

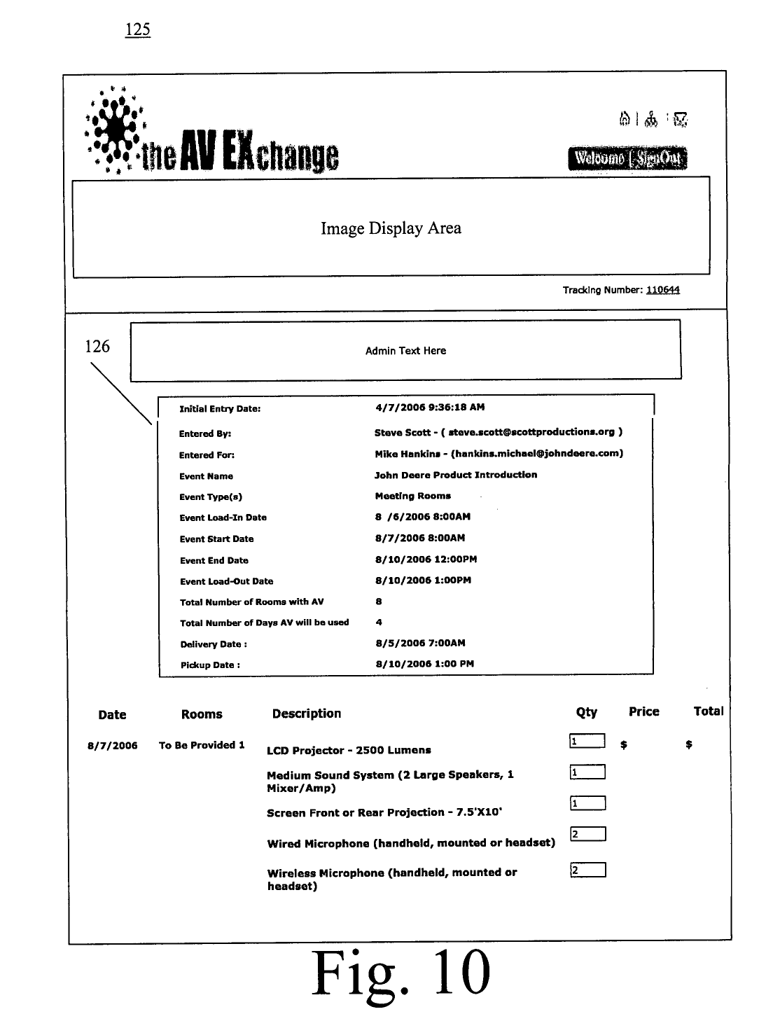

Now referring to FIG. 10 a screenshot of the Internet Website Browser Embodiment 125 of the present invention illustrating the Detailed Budget Estimate 126 is shown. This report includes the same event information as the previous two reports and also includes an itemized list of products and services based on date and location. Quantity, unit price, and extended price are all show as well as summary pricing information.

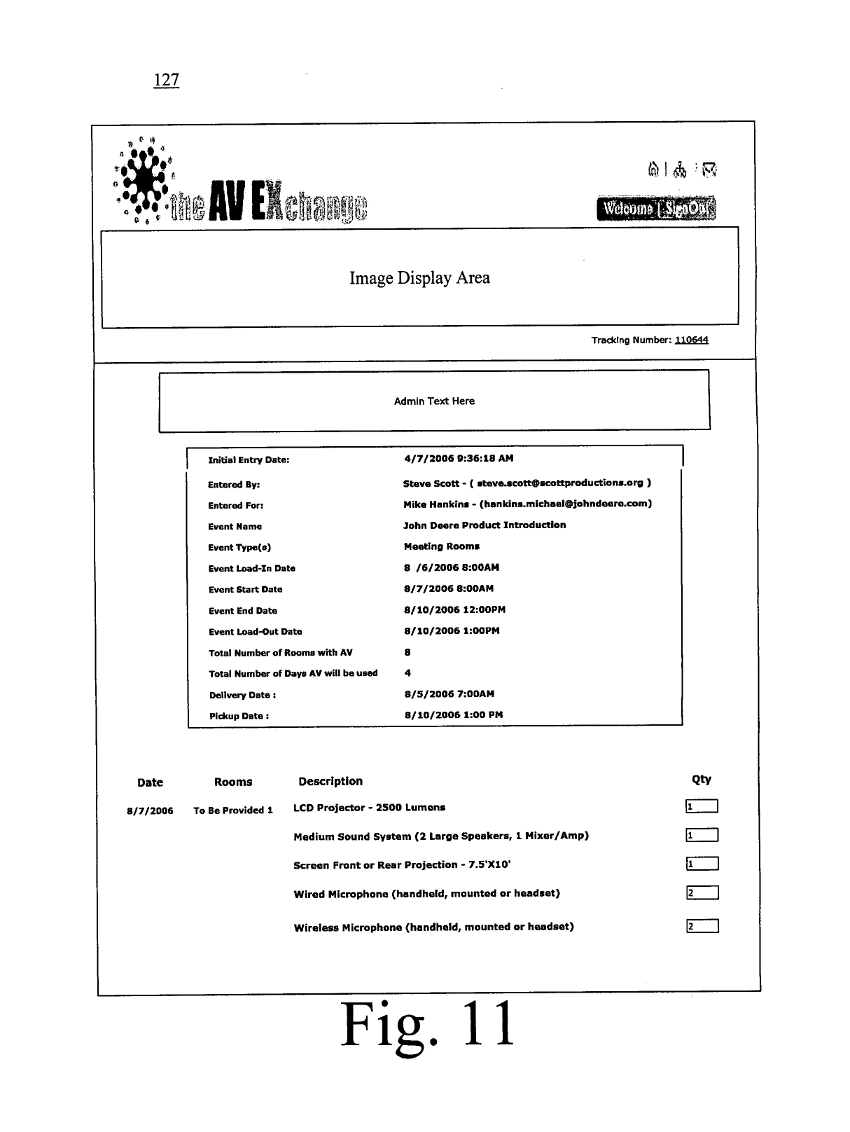

FIG. 11 is a screenshot of the Internet Website Browser Embodiment 127 of the present invention illustrating the Production Copy/Flow Sheets. This report again includes all the same event information as the previous reports, but illustrates the products and services in an itemized list including quantity based on date and room without pricing information. This list is specifically designed to assist the movers during load in operations so that each room is properly equipped each date of the event.

CPG-SML is a list of ALL products selected by a user for the event from a list of all available products in our inventory.

Custom Product Group-To be Assigned List (CPG-TBAL) is the remaining list of items to be assigned to a room.

A user can review their personalized CPG-SML for the event with total anticipated quantities. At anytime the user can return to this page and add or remove a product or adjust the quantities.

In the example the CPG-“Summary Master List” displays a total list of products and quantities selected by a user in Step 4. When a User clicks to continue to Step 5 the list will intuitively or automatically populate the next form and the CPG—Summary Master List will be viewable with a new CPG-“To Be Assigned List.”

Using this technology many items have automatically or intuitively been assigned to rooms. This step will save significant time in having to input or copy and paste redundant information and requires only minimal review to update, add or remove products as needed.

Users would assign the remaining items to the proper rooms for each corresponding day that the item is needed and check existing items that have automatically been assigned for accuracy and then make any necessary adjustments. The User can now choose: Single or multiple Dates; Single or multiple Rooms; Add the appropriate Quantity; or Select the Product to be Updated, Added or Removed. Each time a Product is Updated, Added or Removed, the quantity of the “CPG-To Be Assigned List” should automatically update until all totals are zero. Items remaining to be assigned must equal zero for a User to continue.

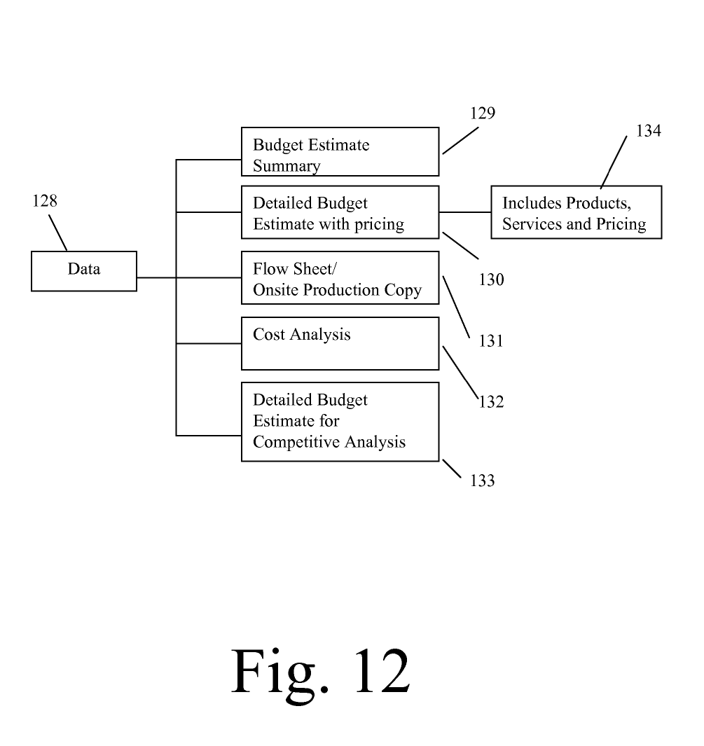

Now referring to FIG. 12, several of the outputs that may be generated by a preferred embodiment of the system of the present invention are illustrated. By combining the system data 128 with the user input, the following can be generated by the system: a budget estimate summary 129; a detailed budget estimate with pricing 130 which includes specific products, services, and pricing 134; a flow sheet/onsite production copy can be printed or electronically distributed 131; a cost analysis report 132; and a detailed budget estimate for competitive analysis 133.

Term of use for the system include but are not limited to Approval, Budget Estimate Conditions, Rates and Conditions, Service and Security, Venue Issues, Labor Scale, Confidentiality, and Collection-Late Fees.

A signed approval must be received by the system in advance of any logistical arrangements being made including but not limited to reserving inventory, reserving technical support, travel arrangements, equipment transportation, etc. A 50% deposit of the estimated final invoice must be received with the signed approval.

Any information not provided in writing or considered to be unknown could affect the enclosed pricing as an increase OR decrease in costs. The system requests that User provide ample opportunity to the system (and User itself) to re-examine the enclosed budget once real specs are available in order to ensure that all aspects of this production are handled in the highest quality as well as most economical fashion.

On-site changes, additions or deletions in services are subject to the rates and conditions in place at the time of the request. The system will receive prior approval from User on costs related to all changes, additions and deletions of service.

Security and storage is required at all times that the equipment is not attended by the system personnel. Any related storage and/or security costs, including theft, are the responsibility of the User or it's designates.

While the system will always strive to minimize workload and assist in finding the best solutions for events, all venue related fees (patch, power, rigging supervision, exclusives, etc.) are the sole responsibility of Customer or it's Designates. Please arrange for any venue related issues directly with the venue, including house sound, electrical, stages, podiums, etc.

Straight Time—Monday-Friday up to 10 hours, Overtime after 10 hours Overtime—Saturday-Sunday Time and a half up to 10 hours, Double-Time after 10 hours Time-and-a-half is applied after 10 hours on weekdays and for the first 10 hours on weekends. Time-and-a-half is applied between 12 am and 6:00 am on weekdays. Time-and-a-half is applied on some holidays, please check with us if your event occurs over a holiday. Double-Time is applied after 10 hours on weekends and holidays and between 12 am and 6:00 am on weekends.

All information in this and the output forms is considered strictly confidential and should not be distributed without prior written permission from the system.

A 1.5% Late Fee, which is an Annual Percentage Rate of 18%, or the highest allowable by law, will be added to all past due accounts. The minimum fee is $5.00 per month.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for organizing and managing audio visual product and service with information comprising the steps of:
registration of a user wherein a first name, last name, email address, login identification and password are entered;
login using a user's identification and password;
estimating,
selecting a new budget estimate
receiving a tracking number inputting information;
submitting information to the system's staff, taking a tour of the system's features, or utilizing a quick assistant;
comparative analysis,
election, and
rental or purchase;
further including specific assessment tools:
a tool for accountability related to variables in pricing,
providing multiple output options from one database, and
providing enterprise wide storage and tracking of historical data for easy future reference and analysis.

2. The method for organizing and managing audio visual product and service with information of claim 1 further comprising the steps of:
entering Room Name Assignments into the system;
creating a Product Inventory List
said Product Inventory List is generated from information provided by or accessed from multiple AV companies and other AV product suppliers; and
indicating a total quantity of products needed for the rooms previously listed and adding products not on the list to receive a price quote;
assigning Products to Rooms wherein a user has selected a plurality of products that will be added to a Custom Product Group—Summary Master List;
automatically assigning the products on a per room basis;
continually automatically assigning the products on a per room basis with each of the products that have equal to or greater quantity values than the number of rooms each being assigned to a room, for products with a total less than that equal to the number of rooms, the products would remain in a To be Assigned status; and
generating a tracking number;
previewing and printing any of the available forms.

3. The method for organizing and managing audio visual product and service with information of claim 2 wherein the order is reviewed for accuracy and an email is sent to the user with a copy of the Budget and Estimate Summary with any adjustments or changes that may have been made, along with an Approval Form for the user to execute and confirm the order.

4. The method for organizing and managing audio visual product and service with information of claim 3 wherein
the Budget Estimate with Pricing report includes a breakdown of event information, products, services, and price total information;
the event information includes the dates, name, contact person, system contact, rooms, and time frame;
with respect to the products and services an itemized list showing the quantity, unit price, days, and total extended price is shown; and
the total section a product total, service total, taxes, and total amount due.

5. The method for organizing and managing audio visual product and service with information of claim 1 wherein information includes event information including, Event Name, Event Types, Event Load-In Date and Time, Event Start Date and Time, Event End Date and Time, Event Load-Out Date and Time, Number of Total Rooms with AV, and Number of Total Days AV.

6. The method for organizing and managing audio visual product and service with information of claim 3 wherein the Budget Estimate without Pricing report is the Budget Estimate with Pricing further comprised of the quantity of products and services does not include any unit or extended pricing information or total section values.

7. The method for organizing and managing audio visual product and service with information of claim 5 wherein the Detailed Budget Estimate is the Budget Estimate with Pricing further comprised of an itemized list of products and services based on date and location; quantity, unit price, and extended price, and summary pricing information.

8. The method for organizing and managing audio visual product and service with information of claim 6 wherein the Detailed Budget Estimate is t Budget Estimate without Pricing further comprised of an itemized list of products and services based on date and location; quantity, unit price, and extended price, and summary pricing information.

9. The method for organizing and managing audio visual product and service with information of claim 8 wherein the Production Copy and Flow Sheets illustrates the products and services in an itemized list including quantity, based on date and room without pricing information.

10. A system for organizing and managing audio visual product and service with information comprising means for:
estimating,
comparative analysis,
election, and
rental or purchase.

11. The system for organizing and managing audio visual product and service with information of claim 10 further specific assessment tools providing:
means for providing accountability related to variables in pricing,
means for providing multiple output options from one database, and
means for providing enterprise wide storage and tracking of historical data for easy future reference and analysis.

12. The system for organizing and managing audio visual product and service with information of claim 11 further comprising:
means for entering and recording registration of a user's first name, last name, email address, login identification and password on a computer system;
means for login using a user's identification and password to the computer system;
means for estimating price,
means for selecting a new budget estimate
means for receiving a tracking number inputting information;
means for submitting information to the system's staff, taking a tour of the system's features, or utilizing a quick assistant;
means for comparative analysis,
means for election, and
means for rental or purchase.

13. The system for organizing and managing audio visual product and service with information of claim 12 further comprising:
means for entering Room Name Assignments into the system;
means for creating a Product Inventory List
said Product Inventory List is generated from information provided by or accessed from multiple AV companies and other AV product suppliers; and
means for indicating a total quantity of products needed for the rooms previously listed and adding products not on the list to receive a price quote;
means for assigning Products to Rooms wherein a user has selected a plurality of products that will be added to a Custom Product Group—Summary Master List;
means for automatically assigning the products on a per room basis;
means for continually automatically assigning the products on a per room basis with each of the products that have equal to or greater quantity values than the number of rooms each being assigned to a room, for products with a total less than that equal to the number of rooms, the products would remain in a To be Assigned status; and
means for generating a tracking number;
means for previewing and printing any of the available forms.

14. The system for organizing and managing audio visual product and service with information of claim 13 means for reviewing an order for accuracy and an emailing a user with a copy of the Budget and Estimate Summary with any adjustments or changes that may have been made, along with an Approval Form for the user to execute and confirm the order.

15. The system for organizing and managing audio visual product and service with information of claim 14 wherein
the Budget Estimate with Pricing report includes a breakdown of event information, products, services, and price total information;
the event information includes the dates, name, contact person, system contact, rooms, and time frame;
with respect to the products and services an itemized list showing the quantity, unit price, days, and total extended price is shown; and
the total section a product total, service total, taxes, and total amount due.

16. The system for organizing and managing audio visual product and service with information of claim 13 wherein information includes event information including, Event Name, Event Types, Event Load-In Date and Time, Event Start Date and Time, Event End Date and Time, Event Load-Out Date and Time, Number of Total Rooms with AV, and Number of Total Days AV.

17. The system for organizing and managing audio visual product and service with information of claim 15 wherein the Budget Estimate without Pricing report is the Budget Estimate with Pricing further comprised of the quantity of products and services does not include any unit or extended pricing information or total section values.

18. The system for organizing and managing audio visual product and service with information of claim 17 wherein the Detailed Budget Estimate is the Budget Estimate with Pricing further comprised of an itemized list of products and services based on date and location; quantity, unit price, and extended price, and summary pricing information.

19. The system for organizing and managing audio visual product and service with information of claim 18 wherein the Detailed Budget Estimate is t Budget Estimate without Pricing further comprised of an itemized list of products and services based on date and location; quantity, unit price, and extended price, and summary pricing information.

20. The system for organizing and managing audio visual product and service with information of claim 19 wherein the Production Copy and Flow Sheets illustrates the products and services in an itemized list including quantity, based on date and room without pricing information.
